(19) United States
(12) Patent Application Publication
(10) Pub. No.: US 2005/0220942 A1
(43) Pub. Date: Oct. 6, 2005

(54) Easy to peal vacuum packaging bags

(76) Inventors: Hongyu Wu, San Jose, CA (US); Lawrence Chen, Concord, CA (US); Charles Wade Albritton, Hercules, CA (US)

Correspondence Address: PERKINS COIE LLP, P.O. BOX 2168, MENLO PARK, CA, 94026, US

(21) Appl. No.: 11/058,925

(22) Filed: Feb. 15, 2005

Related U.S. Application Data
(60) Provisional application No. 60/553,693, filed on Mar. 15, 2004.

(51) Int. Cl. A23B 4/00

(52) U.S. Cl. 426/124

(57) ABSTRACT

The present invention teaches a film having a pealably sealable layer. When used in the vacuum packaging bag material context, the result is a vacuum packaging bag that a consumer can evacuate and hermetically seal. The consumer may later open the bag through a manual pealing action that does not require a tool and that does not result in wasting or destroying a portion of the vacuum packaging bag. The present invention also contemplates a variety of applications for the pealably sealable films, including preformed bags and bag rolls, as well as a variety of apparatus for manufacturing the films and appliances for utilizing the bags and bag rolls.

This application claims priority to Wu et al.'s U.S. provisional patent application No. 60/553,693, filed Mar. 15, 2004, entitled PEALABLY SEALABLE VACUUM PACKAGING BAGS, the contents of which are incorporated herein by reference.

### TECHNICAL FIELD

The invention relates to vacuum packaging bags for packaging products using a vacuum packaging appliance. In particular, the present invention teaches a film for making pealably sealable vacuum packaging bags and bag rolls, as well as methods and appliances for use therewith.

### BACKGROUND OF THE INVENTION

Vacuum packaging appliances, vacuum packaging bags, film for the manufacture of vacuum packaging bag material, and methods for vacuum packaging product are well known in the art. Prior Art FIGS. 1-8 will be used to describe the vacuum packaging operation in general, setting the stage for the teaching of the present invention.

Prior Art FIG. 1 illustrates a multi-layer film 10 that is one common structural configuration for prior art vacuum packaging bag material. The film 10 includes a permanent sealing resin layer 12, a bond layer 14, a gas impermeable layer 16, a bond layer 18, and a structural layer 20. Bond layers 14 and 18 act to laminate opposing layers. The structural layer 20 provides strength so that the film 10 is useful as a vacuum packaging bag material. The gas impermeable layer 16 tends to inhibit gas flow across the film 10. The permanent sealing resin layer 12 is used to form permanent seals between two sheets of the film 10 as formed in a bag, pouch or storage receptacle. As will be appreciated, preformed vacuum packaging bags and bag roll material are the common commercial end products made from vacuum packaging films such as film 10.

Prior Art FIG. 2 illustrates a vacuum packaging bag 20 ready for use by a consumer. The vacuum packaging bag 20 is made of two sheets 22 and 24 made of vacuum packaging film such as film 10 of FIG. 1. The bag 20 has been heat-sealed on three sides forming permanent seals 26, 28 and 30. In the prior art, these permanent seals are not easily opened, but rather must be opened or cut with a tool such as a scissors. The bag 20 is formed with an opening 32 wherein the user can insert product.

Prior Art FIG. 3 illustrates the vacuum packaging bag 20 after a consumer has inserted a product 40 within the bag 20. As will be appreciated, bags such as bag 20 can be purchased by the consumer in preformed manufacture, or may be formed to a desired size by the consumer using the vacuum packaging appliance and a roll of bag material.

A prior art vacuum packaging appliance 100 is described now with reference to FIGS. 4-5. The vacuum packaging appliance 100 includes a heat seal mechanism 102, a drip trough 104 which is part of a vacuum circuit, a roll 108 of bag material, a control panel 110, and a cutting tool 112. The heat seal mechanism 102 is operable to heat-seal the bag 20. Typically prior art heat seal mechanisms operate in a temperature range of 100-200 degrees Celsius. The heat seal mechanism 102 can operate automatically or manually, depending upon the features of the appliance 100 and as controlled by the consumer through the control panel 110.

With further reference to FIG. 4, the drip trough 104 serves to capture contaminants during evacuation of the bag 20. When the open end 32 of the bag 20 is coupled to the vacuum circuit and the lid of the appliance 100 closed as shown in FIG. 5, the vacuum circuit is closed and the bag 20 may be evacuated.

The roll 108 has preformed heat seals 26 and 30 on opposing sides. The roll 108 may be unfurled by the consumer to form a bag of any desired length. The cutting tool 112 is operable to cut the unfurled bag material. When creating bags of desired size, the consumer typically adds a third permanent seal before placing the product 40 in the bag 20.

Prior Art FIG. 6 is a flow chart illustrating a method 50 for vacuum sealing, storing and then accessing a product in a vacuum packaging bag. In an initial step 52, the consumer prepares a vacuum packaging bag 20 for use. This may involve the consumer using an appliance to form the bag 20 from bag roll material, i.e., cutting the desired amount of bag material and forming the third seal and leaving an open end. Alternatively, the consumer may utilize a preformed bag 20.

In a next step 54, a product 40 is placed within the bag 20, as illustrated in FIG. 4. The product 40 may be food, collectible items, or anything the consumer desires to store in an evacuated bag. In a step 56, the consumer couples the bag 20 holding product 40 to the vacuum circuit of the appliance 100. This is illustrated in FIGS. 4-5. In a step 58, the consumer activates the appliance 100 to evacuate the bag 20. The vacuum level may be predefined and reached automatically, or may be controlled by the consumer. In any event, once the desired vacuum level is reached in the bag 20, the consumer activates the heat sealing mechanism 102 that then permanently seals the bag 20. As shown in FIG. 7, the bag 20 now has a fourth seal 34. The seal 34 formed in the bag 20 is permanent and cannot be opened manually, i.e., the seal must be cut off or the bag 20 destroyed in order to access the contents of the bag 20.

In a step 62, the consumer stores the product 40 in the vacuum-sealed bag 20. For example, when the product is food, the consumer may store the bag 20 in a fridge or freezer. Once the user desires to access the product, the bag 20 must be destroyed by using a tool such as a scissors 42 to cut through the bag 20. As shown in FIG. 8, in a step 64, the consumer uses the scissors 42 or other tool to open the bag to access the product 40. Then in a step 66, the consumer may reuse any remaining portion of the bag.

There are at least two drawbacks to the prior art vacuum packaging storage systems. First, a consumer is required to use a tool such as a scissors to open the bag 20 after sealing. This renders use of the vacuum packaging bag inconvenient for the consumer in any setting where a scissors is not readily available, makes the vacuum packaging bag less portable, etc. Second, in opening the bag to access the product, a portion of the bag is destroyed. As a result, the bag material is not efficiently used, forcing the consumer to purchase additional product while having detrimental effects on the environment.

### SUMMARY OF THE INVENTION

The present invention teaches a variety of films each having an easy to peal, or pealably sealable, layer. This provides for a vacuum packaging bag that a consumer can evacuate, hermetically seal, and then later open through a manual pealing action. The manual pealing action does not require a tool and does not result in wasting or destroying a portion of the vacuum packaging bag. The present invention also contemplates a variety of applications for the pealably sealable films, including preformed bags and bag rolls, as well as a variety of apparatus for manufacturing the films and appliances for utilizing the bags and bag rolls.

### BRIEF DESCRIPTION OF THE DRAWINGS

Prior Art FIG. 1 is a cross-sectional view of a plastic film used for forming vacuum packaging bags according to the prior art.

Prior Art FIG. 2 is an isometric view of a vacuum packaging bag of the prior art as ready for use.

Prior Art FIG. 3 is an isometric view of a vacuum packaging bag holding a product prior to evacuation and permanent sealing according to the prior art.

Prior Art FIG. 4 is an isometric view of a vacuum packaging bag holding a product, the bag inserted into a vacuum packaging appliance according to the prior art.

Prior Art FIG. 5 is an isometric view of vacuum packaging appliance evacuating and sealing a vacuum packaging bag according to the prior art.

Prior Art FIG. 6 is a flow chart showing a method of vacuum packaging a product in a permanently sealed bag and then opening the permanently sealed bag with a tool, as required by the prior art.

Prior Art FIG. 7 is a top view of a permanently sealed vacuum packaging bag according to the prior art.

Prior Art FIG. 8 is a top view of a user opening a permanently sealed vacuum packaging bag with a tool according to the prior art.

FIG. 9 is a cross-section of a film suitable for forming a pealably sealable vacuum packaging bag in accordance with one embodiment of the present invention.

FIG. 10 is a cross-section of another film suitable for forming a pealably sealable vacuum packaging bag in accordance with yet another embodiment of the present invention.

FIG. 11 is a top view of a vacuum packaging bag having at least one pealable seal according to one embodiment of the present invention.

FIG. 12 is a flow chart illustrating a method for pealably sealing a vacuum packaging bag according to one aspect of the present invention.

FIG. 13 is an apparatus for manufacturing a roll of pealably sealable bag material.

FIG. 14 is a vacuum packaging appliance in accordance with another embodiment of the present invention.

### DETAILED DESCRIPTION

FIGS. 1-8 show prior art.

The present invention teaches a film having a pealably sealable layer. When used in the vacuum packaging bag material context, the result is a vacuum packaging bag which a consumer can evacuate, hermetically seal, and then later open through a manual pealing action. The manual pealing action does not require a tool and does not result in wasting or destroying a portion of the vacuum packaging bag. The present invention also contemplates a variety of applications for the pealably sealable films, including preformed bags and bag rolls, as well as a variety of apparatus for manufacturing the films and appliances for utilizing the bags and bag rolls.

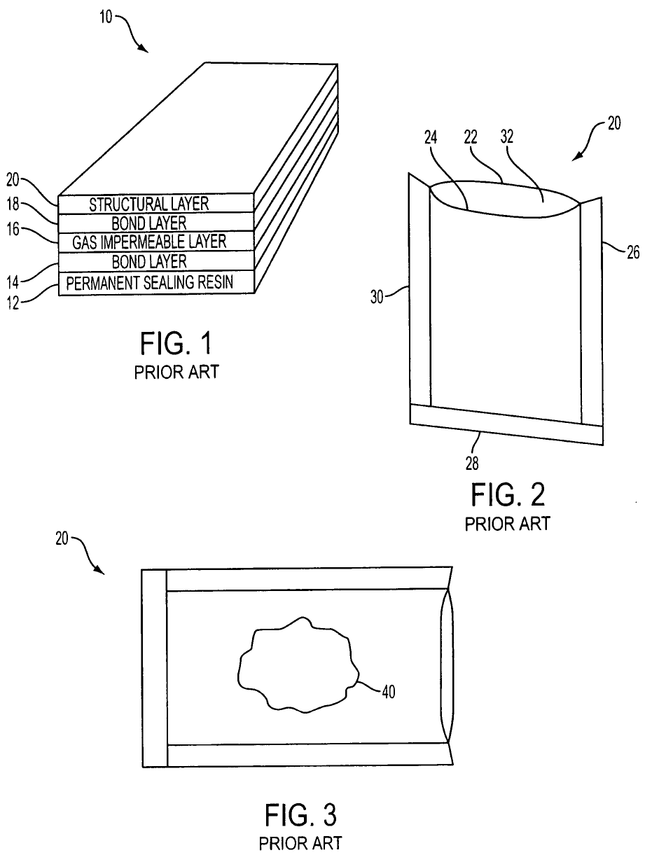

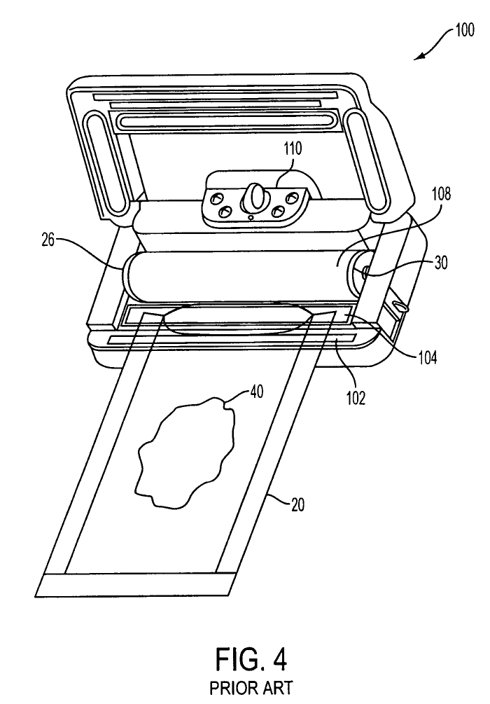

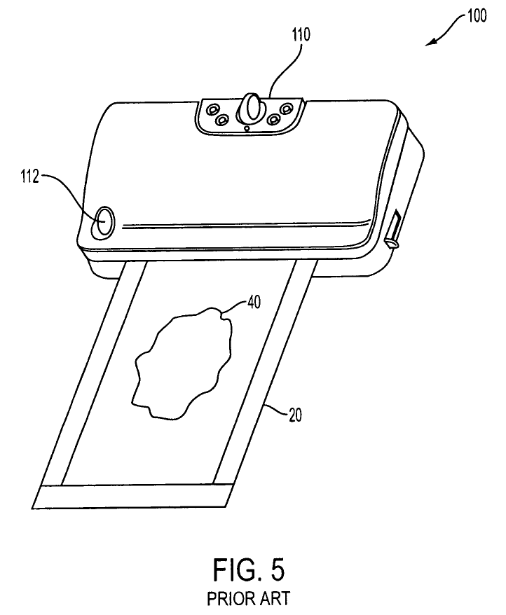

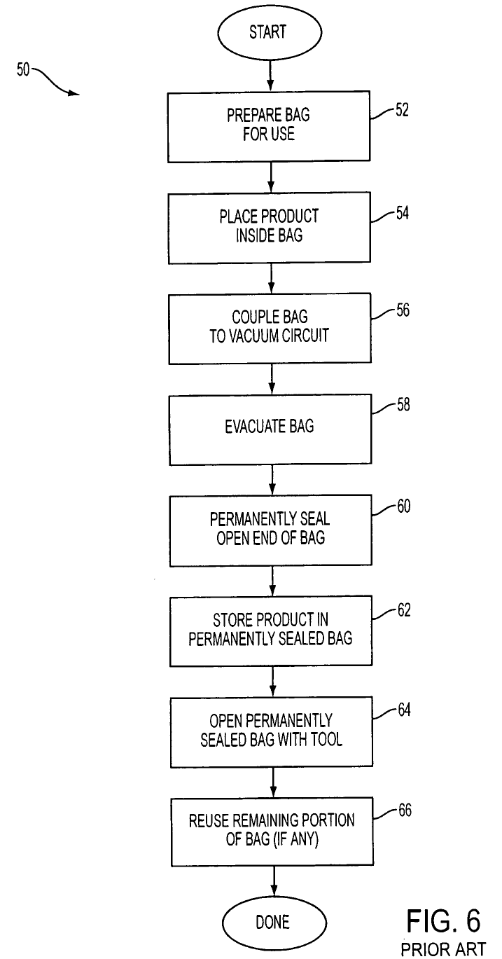

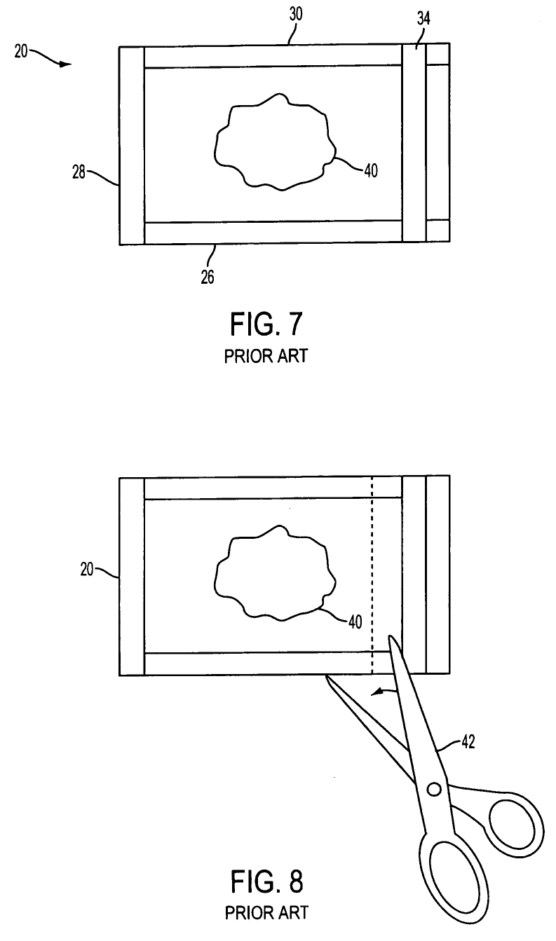

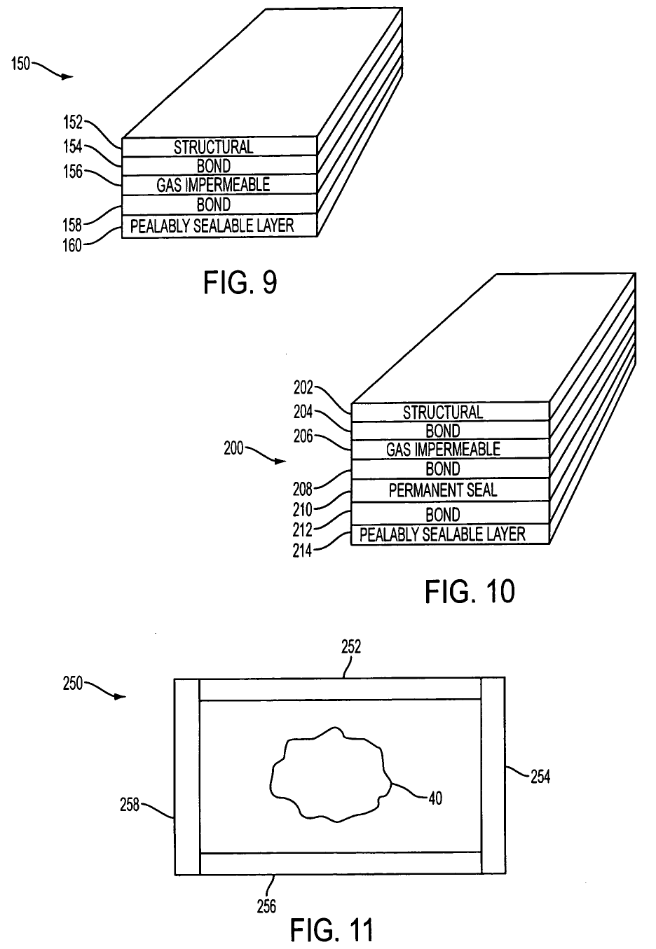

FIG. 9 illustrates a multi-layer film 150 according to one embodiment of the present invention. The film 150 includes a structural layer 152, a bonding layer 154, a gas impermeable layer 156, a bonding layer 158, and a pealably sealable layer 160. Bond layers 154 and 158 act to laminate opposing layers. The structural layer 152 provides strength to the film 150 so that it is particularly useful as a vacuum packaging bag material. The gas impermeable layer 156 tends to inhibit gas flow across the film 10.

The pealably sealable layer 160 includes a resin or other material that through pressure, heat or other sealing enabler, will form a pealable seal. The pealable seal will be capable of holding a vacuum level in an evacuated bag, yet will be manually pealable by a user. In certain embodiments, the vacuum internal to the bag will tend to maintain the seal, thus making this operation even easier. In other embodiments, the pressure arising from the internal vacuum is sufficient to maintain the pealable seal.

A variety of materials are well suited for the material of the pealably sealable layer 160. For example, the material of pealably sealable layer 160 may include polyethylene, polyester, ethylene vinyl acetate, etc., and resins thereof. Typical vacuum packaging appliances operate their heat sealing mechanisms in temperature ranges of 100 degrees Celsius to 200 degrees Celsius. Therefore certain embodiments of the present invention teach materials which will form the pealably sealable bond within that temperature range. Other embodiments of the present invention teach materials which pealably seal in temperature ranges falling outside the temperature ranges of current appliances. In these embodiments, the home vacuum packaging appliances must be designed accordingly.

The present invention also contemplates forming the pealably sealable layer 160 out of material that may form a permanent seal under a first set of conditions, and a pealable seal under a second set of conditions. For example, the material may form a pealable seal under sealing pressure and temperature conditions of the typical home vacuum packaging appliance. Under more extreme pressure and/or temperature conditions, the material of this embodiment may form a permanent bond. This is useful in that bags and bag rolls with preformed permanent seals can be manufactured and sold to the consumer. The consumer in turn can form the final fourth seal with a pealably sealable bond using a standard appliance. This is preferable in certain circumstances, as only one pealable seal is necessary for easy access to the content of the bag.

FIG. 10 illustrates a multi-layer film 200 in accordance with another embodiment of the present invention. The film 200 includes a structural layer 202, a bond layer 204, a gas impermeable layer 206, a bond layer 208, a permanent sealing layer 210, a bond layer 212, and a pealably sealable layer 214. As described above with reference to FIG. 9, under certain circumstances there are advantages to having a film with permanent sealing capabilities. The film 200 includes the permanent sealing layer 210 that under certain conditions can be used to generate a permanent bond.

As will be appreciated, the multi-layer films of FIGS. 9-10 are two possible embodiments of films for use in vacuum packaging materials. The common feature is the inclusion of a layer that is pealably sealable under at least some condition, and the present invention contemplates any film having such a layer.

Those skilled in the art will readily recognize that films of the present invention may be beneficially designed with patterns therein or upon. Patterned film has the property of tending to form air channels during evacuation of a bag made from such patterned material, the air channels tending to improve evacuation of these bags. Suitable patterns include waffle-shaped, straight-lined, zigzag, speckled and random patterns.

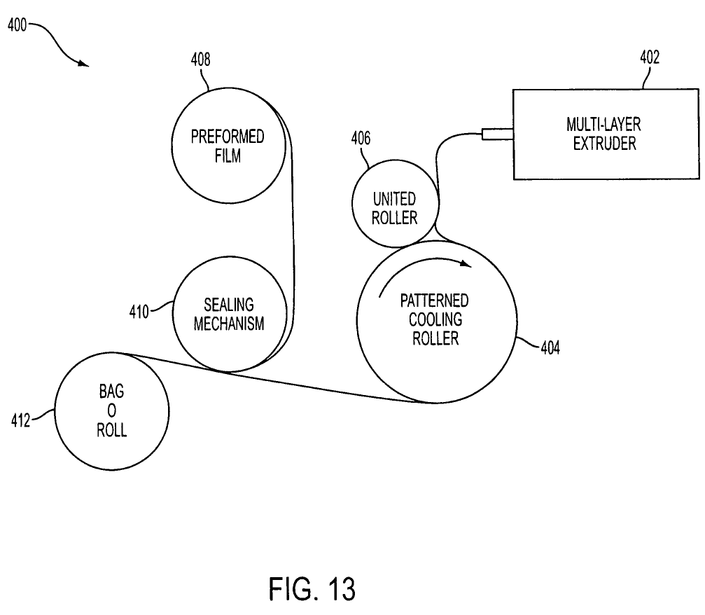

The multi-layer films may be formed by extrusion processes such as described below with reference to FIG. 13, or through embossing. Suitable patterns, as well as extrusion and embossing processes, are described in more detail in Wu's commonly assigned U.S. patent application Ser. No. 10/801,950, filed Mar. 15, 2004, and incorporated by reference in its entirety.

FIG. 11 illustrates a vacuum packaging bag 250 storing product 40 in accordance with one embodiment of the present invention. The bag 250 has been evacuated and seals 252-258 have been formed. Depending upon the application and the film used for the bag material, at least one of the seals 252-258 is a pealable seal. The other seals may be formed as permanent seals, if the film and available equipment permits, and may also be formed as pealable seals. The existence of at least one pealable seal permits manual access to the product 40 stored in the bag 250 without the use of a tool and without wasting bag material.

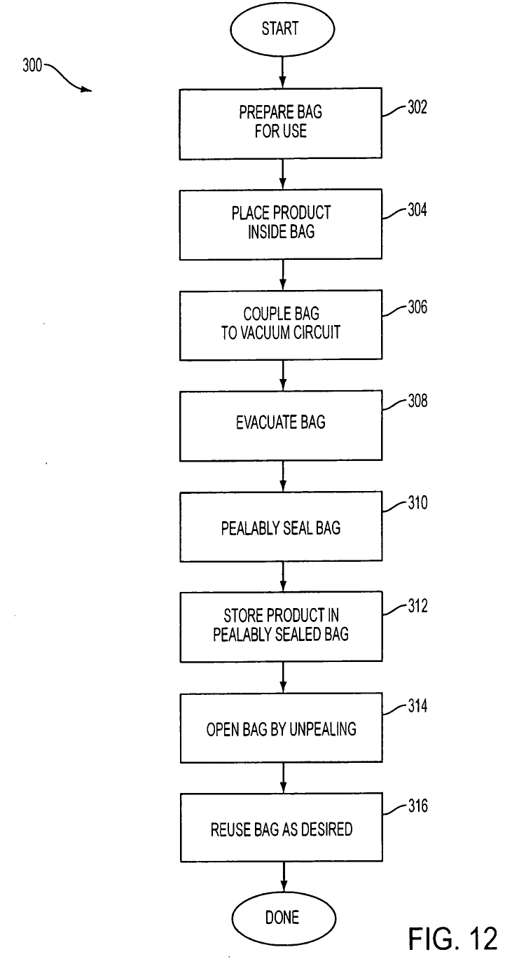

FIG. 12 is a flow chart illustrating a method 300 according to one aspect of the present invention. The method 300 begins in a step 302 wherein a user prepares a bag for use in vacuum packaging a product. Step 302 involves the user obtaining a preformed bag or preparing a bag of desired size from a bag roll. As described above, the three seals of a prepared bag may be permanent seals or pealable seals, depending upon the film used, the available heat sealing mechanism, etc. In a step 304, the user places the product (e.g., food) inside of the prepared bag through the open end.

In a step 306, the user couples the bag to the vacuum circuit of the vacuum packaging appliance. This typically involves placing the open end of the bag into the vacuum chamber of the appliance and closing the appliance lid. However, the present invention also contemplates closed chamber systems wherein the entire back is placed inside of a vacuum chamber. In any event, in a step 308 the user evacuates the bag by activating the vacuum packaging appliance and then a step 310 pealably seals the bag. The step 310 may involve applying heat, pressure, or both, in a predefned range and for a predefined time period, to the open portion of the bag. In a step 312, the user stores the packaged product as desired.

In a step 314, the user accesses the product by simply pealing open the pealable seal of the bag. This allows easy access to the product without the use of a tool such as a scissors and without wasting bag material. This enables a step 316 wherein the user may reuse the entire bag.

FIG. 13 illustrates an apparatus 400 for manufacturing bag material in accordance with one embodiment of the present invention. The apparatus 400 includes a multi-layer extruder 402 for extruding a first film sheet, a patterned cooling roller 404, a laminating roller 406, a second film source 408 providing a second film sheet, a sealing mechanism 410, and a bag roll 412.

The multi-layer extruder 402 extrudes one or more materials for forming the bag material. This includes the pealably sealable material and typically includes a gas impermeable layer.

The patterned cooling roller 404 forms a pattern on the bag material that causes air channels to form during and aid in evacuation of the bag. The laminating roller 406 applies the extruded material onto the cooling roller 404 so that the pattern is properly formed on the bag material.

The preformed film source 408 is a source of film for the second sheet of the bag material. The source 408 may be another extruding mechanism, cooling roller, etc., or may simply be a roll of already formed film. The second sheet of film may or may not be patterned. The heat sealing mechanism 410 is arranged to bond the first and second sheets of film on outer opposing edges. The bag material formed on bag roll 412 is a roll of bag material having seals on opposing sides. These seals may be permanent seals or pealably sealable, depending upon the film material, the conditions imposed by the sealing mechanism, etc. The bag material is later cut up into bag pouches either by the consumer, or at a next stage of manufacturing for generating preformed bags for the user.

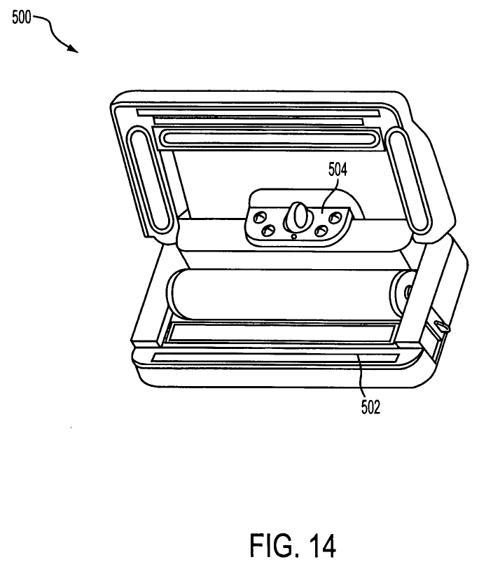

FIG. 14 is an isometric view of a vacuum packaging appliance 500 in accordance with one embodiment of the present invention. Operation and manufacture of such appliances are well known in the art. The appliance 500 includes a heat-sealing mechanism 502 and a control panel 504. The appliance 500 is well suited for use with a film of the present invention having a pealably sealable layer, as well as a layer that can form a permanent seal. As described above, this may be the pealably sealable layer or another layer. In any event, the control panel 504 allows the user to select between forming a permanent seal and forming a pealable seal within the heat-sealing mechanism. This may come from a different temperature setting, different pressure, time duration of the sealing process, etc.

1. A vacuum packaging bag that a user can place a product in, vacuum evacuate the vacuum packaging bag to a predefined vacuum level, hermetically seal through a predefined sealing process, the vacuum packaging bag characterized in that the user can open at least one seal of the vacuum packaging bag through a manual pealing action that does not require a tool and that tends not to waste or destroy any portion of the vacuum packaging bag.

2. A vacuum packaging film suitable for use in forming pealably sealable vacuum packaging bags, said vacuum packaging film comprising:
a gas impermeable layer;
a pealably sealable layer characterized in that said pealably sealable layer forms a pealably sealable coupling with an opposing pealably sealable layer when said pealably sealable layer and said opposing pealably sealable layer are brought together under pressure and/or heat; and
said pealably sealable coupling sufficient to maintain a predetermined vacuum pressure seal, and be manually pealable by a typical user.

3. A vacuum packaging film as recited in claim 2, wherein said pealably sealable layer is made of a material that pealably bonds with said opposing pealably sealable layer when heated to temperatures of about 100 degrees Celsius to 200 degrees Celsius.

4. A vacuum packaging film as recited in claim 3, wherein said material of said pealably sealable layer forms a substantially permanent bond with said opposing pealably sealable layer when heated to temperatures above about 200 degrees Celsius.

5. A vacuum packaging film as recited in claim 4, wherein said material includes a polyester.

6. A vacuum packaging film as recited in claim 4, wherein said material includes a polypropylene.

7. A vacuum packaging film as recited in claim 4, wherein said material includes an ethylene vinyl acetate.

8. A vacuum packaging film as recited in claim 2, wherein said vacuum packaging film has a pattern that operates to form channels suitable for evacuation of gas when said film is used in the creation of a vacuum packaging bag.

9. A vacuum packaging film as recited in claim 8, wherein said pattern is a wave pattern.

10. A vacuum packaging film as recited in claim 8, wherein said pattern is a criss-cross pattern.

11. A vacuum packaging film as recited in claim 8, wherein said pattern is a straight-line pattern.

12. A vacuum packaging film as recited in claim 8, wherein said pattern is an uneven pattern.

13. A vacuum packaging film as recited in claim 8, wherein said pattern is a zigzag pattern.

14. A multi-layer film suitable for use in forming a vacuum packaging bag, said multi-layer film comprising:
a patterned inner layer formed of a first material capable of forming a pealable vacuum seal under predefined conditions, said patterned inner layer having a plurality of grooves which operate to form channels suitable for evacuation of gas when said multi-layer film is used to form a vacuum packaging bag, said inner layer formed through heat extrusion of said first material onto a patterned cold roll, whereby said inner layer has a substantially uniform distribution of material, whereby said inner layer substantially lacks deformities typically present in an embossed film having a similar pattern formed by an embossing process; and
an outer layer laminated onto said patterned layer.

15. A pealably sealable vacuum packaging bag for holding food or other product, said heat-sealable vacuum packaging bag comprising:
a first sheet formed of a multi-layer plastic film, said multi-layer plastic film including:
a patterned inner layer formed of a heat-sealable resin, said heat-sealable resin capable of forming a pealable seal under a predefined set of conditions, said patterned inner layer having a plurality of grooves which operate to form channels suitable for evacuation of gas when said multi-layer film is used to form said vacuum packaging bag; and
an outer layer laminated onto said patterned inner layer, said outer layer including a gas impermeable material;
a second sheet having a footprint similar to said first sheet; and
said first and second sheets arranged with said patterned inner layer inside and facing said second sheet, said first and second sheets heat-sealed on opposing lateral sides and at an end side,
whereby said first and second sheet form said vacuum packaging bag having an opening for insertion of food or other product, said vacuum packaging bag pealably sealable at said opening.

16. A pealably sealable vacuum packaging bag as recited in claim 15, said heat-sealable resin including a polyethylene

17. A pealably sealable vacuum packaging bag as recited in claim 15, said heat-sealable resin including polypropylene.

18. A pealably sealable vacuum packaging bag as recited in claim 15, wherein said heat-sealable resin includes ethylene vinyl acetate.

19. A pealably sealable vacuum packaging bag as recited in claim 15, wherein said pattern includes a wave pattern.

20. A pealably sealable vacuum packaging bag as recited in claim 15, wherein said pattern includes a criss-cross pattern.

21. A pealably sealable vacuum packaging bag as recited in claim 15, wherein said pattern includes a straight-line pattern.

22. A pealably sealable vacuum packaging bag as recited in claim 15, wherein said pattern includes an uneven pattern.

23. A pealably sealable vacuum packaging bag as recited in claim 15, wherein said pattern includes a zigzag pattern.

24. A pealably sealable vacuum packaging bag as recited in claim 15, wherein said heat-sealable resin is capable of forming a permanent seal under a second predefined set of conditions.

25. A pealably sealable vacuum packaging bag as recited in claim 15, wherein said heat-seals on said opposing lateral sides and said end side are permanent seals.

26. A pealably sealable vacuum packaging bag as recited in claim 15, wherein said second sheet is a patterned sheet having a pealably sealable inner layer.

27. A bag roll suitable for forming pealably sealable vacuum packaging bags for holding food or other product, said bag roll comprising:
a first sheet formed of a multi-layer plastic film, said multi-layer plastic film including:
a patterned inner layer formed of a heat-sealable resin, said heat-sealable resin capable of forming a pealable seal under a predefined set of conditions, said patterned inner layer having a plurality of grooves which operate to form channels suitable for evacuation of gas when said multi-layer film is used to form said vacuum packaging bag; and
an outer layer laminated onto said patterned inner layer, said outer layer including a gas impermeable material;
a second sheet having a shape and size substantially similar to said first sheet; and
said first and second sheets arranged with said patterned inner layer facing inside, said first and second sheets heat-sealed on opposing lateral sides,
whereby portions of said bag roll may be cut from said bag roll, thereby creating a partially formed bag having opposing open ends that are heat-sealable.

28. A bag roll for forming pealably sealable vacuum packaging bag as recited in claim 27, said heat-sealable resin including a polyethylene

29. A bag roll for forming pealably sealable vacuum packaging bag as recited in claim 27, said heat-sealable resin including polypropylene.

30. A bag roll for forming pealably sealable vacuum packaging bag as recited in claim 27, wherein said heat-sealable resin includes ethylene vinyl acetate.

31. A bag roll for forming pealably sealable vacuum packaging bag as recited in claim 27, wherein said pattern includes a wave pattern.

32. A bag roll for forming pealably sealable vacuum packaging bag as recited in claim 27, wherein said pattern includes a criss-cross pattern.

33. A bag roll for forming pealably sealable vacuum packaging bag as recited in claim 27, wherein said pattern includes a straight-line pattern.

34. A bag roll for forming pealably sealable vacuum packaging bag as recited in claim 27, wherein said pattern includes an uneven pattern.

35. A bag roll for forming pealably sealable vacuum packaging bag as recited in claim 27, wherein said pattern includes a zigzag pattern.

36. A bag roll for forming pealably sealable vacuum packaging bag as recited in claim 27, wherein said heat-sealable resin is capable of forming a permanent seal under a second predefined set of conditions.

37. A bag roll for forming pealably sealable vacuum packaging bag as recited in claim 27, wherein said heat-seals on said opposing lateral sides are permanent seals.

38. A bag roll for forming pealably sealable vacuum packaging bag as recited in claim 27, wherein said second sheet is a patterned sheet having a pealably sealable inner layer.

39. A method for manufacturing a multi-layer film for use in pealably sealable vacuum packaging applications, said multi-layer film having a pattern which operates to form channels suitable for evacuation of gas when said multi-layer film is used in the creation of a vacuum packaging bag, said method comprising the acts of:
heat-extruding a first material onto a spinning cooling roll, said first material capable of forming a pealably sealable coupling for use in a pealably sealable vacuum packaging bag;
heat-extruding a second material onto said spinning cooling roll such that said first and second extruded materials bond and form first and second layers of said multi-layer film during a cooling of said first and second extruded materials, said first material being a gas impermeable material; and
applying a pattern to said first and second layers in conjunction with said extrusion and said cooling of said first and second extruded materials such that said pattern is defined during said cooling of said first and second materials, said pattern operable to form channels suitable for evacuation of gas from said vacuum packaging bag made of said multi-layer film.

40. A method for manufacturing a multi-layer film as recited in claim 39, further including the act of heat-extruding a first bonding material in between said first and second material, said first bonding material forming a first bonding layer between said first and second layers.

41. A method for manufacturing a multi-layer film as recited in claim 40, further comprising the act of heat-extruding a second bonding material and a structural material to form a second bonding layer and a structural layer, said second bonding layer bonding said structural layer to said second layer, said structural layer intended to provide additional strength to said multi-layer film.

42. A method for manufacturing a multi-layer film as recited in claim 39, wherein the act of applying a pattern to said first and second layers is accomplished by providing said pattern on the circumferential surface of said cooling roll.

43. A method for manufacturing a multi-layer film as recited in claim 42, further including the act of positioning a laminating roll to apply pressure to the extruded materials in order to apply said pattern formed on the circumferential surface of said cooling roll onto said multi-layer film.

44. A method for manufacturing a multi-layer film as recited in claim 39, wherein said pattern is a zigzag pattern.

45. A method for manufacturing a pealably sealable vacuum packaging bag, said method comprising:
a) forming a first patterned film sheet including:
i) heat-extruding a first material onto a spinning cooling roll, said first material capable of forming a pealably sealable coupling;
ii) heat-extruding a second material onto said spinning cooling roll such that said first and second extruded materials bond and form first and second layers of said first patterned film during a cooling of said first and second extruded materials; and
iii) applying a pattern to said first and second layers in conjunction with said extrusion and said cooling of said first and second extruded materials such that said pattern is defined during said cooling of said first and second materials, said pattern operable to form channels suitable for evacuation of gas from said vacuum packaging bag made of said first patterned film sheet;
b) bonding a second film sheet onto said first film sheet via sealing opposing sides to form a pouch with two open ends;
c) sizing said pouch to a desired size; and
d) bonding a one of said open ends to form a vacuum packaging bag having only one opened end.

46. A method of manufacturing as recited in claim 45, wherein said bonding steps b) and d) are performed such that bonds formed on the three sides of said vacuum packaging bag are permanent seals.

47. An apparatus for manufacturing a multi-layer film for use in vacuum packaging applications, said multi-layer film having a pattern that operates to form channels suitable for evacuation of gas when said multi-layer film is used in the creation of a vacuum packaging bag, said vacuum packaging bag being pealably sealable, said apparatus comprising:
a multi-layer extruder for extruding a first material and a second material, said first material being pealably sealable;
a cooling roll positioned with respect to said extruder such that said extruder applies said first and second materials onto a circumferential surface of said cooling roll such that said first and second extruded materials bond and form first and second layers of a first multi-layer film during a cooling of said first and second extruded materials; and
a pattern forming mechanism arranged to pattern said first and second layers during said extrusion and cooling of said first and second materials.

48. A vacuum packaging appliance for evacuating a bag including a film having pealable and permanent sealing capabilities, the vacuum packaging appliance capable to generate conditions for forming a pealable seal and a permanent seal, the vacuum packaging appliance comprising:
a base defining an upper support surface adapted to receive an open end of a bag;
a lid operatively associated with said base, said lid and said base defining a vacuum chamber therebetween to receive said open end of said bag;
at least one gasket surrounding said vacuum chamber for directly engaging said bag such that said open end of said bag is operatively associated with said vacuum chamber;
a vacuum source operatively associated with said vacuum chamber for selectively evacuating said vacuum chamber and said operatively associated bag;
a trough coupled to said base for receiving an open end of said bag and collecting contents taken from said bag while evacuating said bag, wherein a sealing mechanism is located adjacent to said trough in order to seal said evacuated bag; and
a sealing controller that allows an operator to select a type of seal formed on said evacuated bag via said sealing mechanism, said types of seal including pealable and permanent.

49. A vacuum packaging appliance as recited in claim 48, wherein said sealing mechanism is a heat sealing mechanism.
